(19) United States
(12) Patent Application Publication
(10) Pub. No.: US 2018/0112807 A1
(43) Pub. Date: Apr. 26, 2018

(54) PLUG CONNECTION FOR FLUID LINES, INCLUDING A RETAINING PART AND A SECONDARY LOCK

(71) Applicant: VOSS AUTOMOTIVE GMBH, Wipperfurth (DE)

(72) Inventor: Ulrich ERB, Koln (DE)

(21) Appl. No.: 15/568,228

(22) PCT Filed: Mar. 18, 2016
(86) PCT No.: PCT/EP2016/055952

§ 371 Date: Oct. 20, 2017

(30) Foreign Application Priority Data
Apr. 21, 2015 (DE) 10 2015 106 063.9

(51) Int. Cl. F16L 37/12; F16L 37/088; F16L 37/084

(52) U.S. Cl. CPC F16L 37/1225; F16L 2201/20; F16L 37/0841; F16L 37/088

(57) ABSTRACT

A plug connection including two coupling parts releasably locked by a locking device. The locking device includes a retaining part and two retaining webs, one on each coupling part. The retaining part can be assembled on one of the coupling parts, in a pre-assembled state, and, in the assembled state, includes C-shaped retaining portions that axially and radially surround the retaining webs. The retaining part also has an actuation region that operates to spread open the retaining portions when a release force is applied on the actuation region. A locking part is configured such that the locking part can be moved transversely from a release position into a locking position. In the release position, the locking part allows radial movement of the retaining part out of the assembled state and, in the locking position, prevents a radial movement of the retaining part out of the assembled state.

### BACKGROUND

### 1. Field of the Invention

The present invention relates to a plug connection for fluid lines, comprising two coupling parts which can be plugged together and which can be releasably locked by a locking device consisting of two outer radial retaining webs of the two coupling parts, said webs being axially adjacent in the plug-in direction in the plugged state, and a retaining part with an annular contour which can be assembled and secured axially and radially on one of the two coupling parts in a pre-assembled state, and at least one C-shaped retaining section featuring two collars and which is radially movable in a spring-elastic manner, wherein the retaining section surrounds the retaining webs of the two coupling parts in an axial and radial manner in the assembled state.

In this regard the retaining part can have preferably at least one actuation region for spreading open the retaining sections which are radially movable in a spring-elastic manner when a release force applied in the radial direction acts on the actuation region.

The two pluggable coupling parts can pertain, in particular, to a first coupling part which is designed as an insertion part, and to a second coupling part which is designed as a sleeve part with a receiving opening, wherein the insertion part, in particular with an insertion shaft with preferably a collar located thereon, can be inserted into the receiving opening of the sleeve part.

Furthermore, the present invention pertains to a retaining part for creation of this kind of plug connection between two coupling parts, which features a ring contour and at least one C-shaped retaining section featuring two collars and which is radially movable in a spring-elastic manner, wherein the retaining section engages the retaining webs of the two coupling parts in an axial and radial manner and an actuation region for spreading open the retaining sections which are radially movable in a spring-elastic manner when a release force applied in the radial direction acts on the actuation region.

### 2. Description of Related Technology

A plug connection of the type to which the present disclosure is directed is known from WO 2006/018384 A1, which proceeds from a known locking principle by which a C-shaped retaining section of a retaining part engages retaining webs of coupling parts in an interference-fit manner and thus locks them. To reduce the risk of loss of the retaining part and to simplify the assembly, especially also in cases wherein there is very little space available at the assembly site or wherein at least one valve is to be integrated into the coupling parts, it is provided therein that the retaining part is designed and preassembled or can be preassembled to the one of the two coupling parts, such that firstly, it is attached with little axial free play and is radially secured against loss, and secondly it can move in a radial elastic manner in the region of the retaining section. The retaining part here is designed in the region of the retaining section, and also the retaining web of the other coupling part is designed so that they match one another to form an interference-fit locking, snap-in connection such that when plugging the coupling parts together, due to the relative movement of the retaining web, the retaining section is moved radially outward and subsequently, in the inserted state, due to reverse radial movement, engages the retaining webs of the two coupling parts for locking. Preferably the retaining part is designed as a one-part, ring component with an axial and radial slit provided at one perimeter location. This known pluggable connection permits a simple, fast and convenient and also very reliable one-handed assembly. When the retaining part is detached from the coupling parts, in order to reduce the potential for loss, WO 2006/018384 A1 provides for connecting the retaining part via an additional, in particular a band-like or cord-like securing element attachable on one end to the coupling part and on the other end to the retaining part for a loss-proof connection.

German patent application DE 10 2014 102 662.4 proposes an improvement to a pluggable connection of the kind described above, and also an associated retaining part such that while retaining the advantages of the known locking principle, the assembly and disassembly can be further simplified. Accordingly, this proposal provides that the collars of the retaining part are designed with a different size and/or shape so that given a radial elastic movement of the retaining section from the assembled state outward, a collar which rests in the assembled state against the retaining web of the one coupling part, releases this retaining web of the coupling part, whereas the other collar, at least in sections, still engages the retaining web of the other coupling part against which it rests. In this plug connection, the advantages of the known, generic locking principle are combined with the advantages of a snap-in principle. If the retaining part is preassembled in a loss-proof manner to the one coupling part, then the other coupling part need only be inserted axially for the assembly, which allows a simple, fast, convenient and reliable automation or one-hand assembly. Upon detachment of the connection, a powerful, space-consuming radial displacement is not required for disassembly of the retaining part, which is a particular advantage at assembly locations with very little space available in the radial direction. As a particular advantage, a one-finger unlocking is even possible. In this case, a radial expansion can be effected by actuation of or by pressing upon a preferably elastic, pressure surface in an actuation region of the retaining part located between two retaining sections. This pressing is sufficient to extract one coupling part axially from the connection. One of the two collars of the retaining section which rests against the retaining web of the other coupling part against which it rests in the assembled state, and still surrounds during the disassembly, thus remains axially fixed in a ring groove of the coupling part, so that the retaining part continues to be held securely against this coupling part. An open ring contour of the retaining part is formed in that the retaining part features a slit on the side located diametrically opposite the actuation region.

A technical solution similar to the above-mentioned type is also known from DE 10 2012 104 288 A1 for a similar plug connection, but the retaining part there does not have an open, but rather an enclosed perimeter ring contour. This technical solution can provide, in particular, that one of the two collars of the retaining part features a cam-like bulge disposed around the perimeter and additionally being preferably bulged radially inward, by which bulge it is additionally differentiated in size and shape from the other collar and by which it protrudes opposite the other collar, when viewed in axial projection. Except for this bulge, the two collars are otherwise preferably of an entirely equivalent design, especially—when viewed from above—they are preferably congruent. The radial expansion herein can be effected by an activation or pressing on a pressure surface located in a perimeter between two retaining sections, especially an elastic actuation region of the retaining part, e.g. by using a tool to pull or lever the actuation region, and in addition this radial expansion can take place in conjunction with an integral deformation of the entire retaining part, whereas according to German patent application DE 10 2014 102 662.4, owing to the open ring contour, only a spreading of the retaining sections against each other occurs.

In summary it is clear that in the case of plug connections designed in this manner—as mentioned—the C-shaped retaining part is generally preassembled on a coupling part and then after complete assembly of the plug connection, the two retaining collars resting against each other will surround the coupling parts. The spring-elastic force of the retaining part holds it in the retaining position. Due to the release force applied in the radial direction in the actuation region of the retaining part, the retaining element can be spread apart, in particular due to a curved geometry which is braced against one of the coupling parts, and thus the diameter can be enlarged so that a release of the connection is possible.

One disadvantage of both the plug connection according to DE 10 2014 102 662.4 and also of the known plug connection according to DE 10 2012 104 288 A1 is in particular that in certain installation situations it is quite possible that nearby components will exert this release force onto the actuation element of the retaining part and thus an unintended release of the connection can occur. In addition, with these systems it cannot be determined with certainty whether the coupling part is fully inserted and properly blocked against any extraction.

### SUMMARY

The object of the present invention is therefore to design a plug connection of the kind described above wherein the retaining part, when in the assembled state, can be secured against an accidental release and additionally a correct and complete insertion of the one coupling part of the plug connection into the other coupling part can be checked and verified.

This object is achieved according to the principles of the present invention.

Accordingly, the invention provides that a locking part is arranged and is designed such that it can be moved transversely to the axial plug-in direction of the coupling parts from a release position into a locking position, wherein in the release position, the locking part allows a radial movement of the retaining part out of the assembled state and in the locking position prevents a radial movement of the retaining part out of the assembled state.

Thus the additional locking element prevents an accidental loosening of the retaining part in the locking position.

The additional locking element can also be used to advantage both on a retaining part, which is preferably designed—as described above—as a one-part elastic ring with an enclosed perimeter contour, or also as described above, designed with a perimeter contour interrupted by a slit. The term of ring contour and/or ring as used herein does not necessarily mean a circular shaped configuration, but rather also that the retaining part can have an elliptical or oval shape. The retaining part can preferably have two C-shaped retaining sections—when viewed in axial cross section, and in particular with radially symmetrical perimeter distribution—which are located in the longitudinal sides of the perimeter contour.

The locking part can be designed and in particular can be connected to the retaining part in such a manner that its one blocking section, which is positioned in a free space between the actuation section of the retaining part and the retaining collars when the locking part is in the locking position, prevents any radial movement of the retaining part from its assembled state.

In another favorable embodiment of the invention, detachable blocking means prevent the locking part in the release position from moving into the locked position. The blocking means are designed such that upon insertion of the collar of the one coupling part, preferably of the coupling part, in the insertion direction to behind the retaining part, it releases the blocking means and enables a movement of the locking part from the release position into its locking position. This prevents an actuation of the locking element from the release position into the locking position before a complete and correct plugging is affected. Only once the two coupling parts are securely mounted axially and radially by the retaining element will the locking means be released, and the locking element can be moved into the locking position.

In another embodiment of the invention, the locking element is arranged on one of the coupling parts and is designed such that it can be moved transverse to the insertion direction from an additional blocking position into the release position, wherein the locking element in this blocking position of the retaining part prevents the coupling part from being inserted into the sleeve part, as long as the locking part is not located in its release position.

The locking part can be designed in various forms.

For example, it can be configured as a part having basically a U-shaped design, which within the scope of this application is designated as a “transverse lock” and which moves from its released position into the locked position by means of a radial insertion into the retaining part.

Likewise, the locking part can also be configured as a part having basically a C-shaped design, which within the scope of this application is designated as a “rotation lock” and which moves from its released position into the locked position using a perimeter-based rotation into the retaining part.

In both designs the locking part can comprise at least one actuation section, one locking arm, one blocking section, one radially movable section, one insertion slant surface, means to implement an insertion check and anti-loss means.

Additional favorable embodiments of the invention are evident from the following description of the Figures and from the dependent claims.

### BRIEF DESCRIPTION OF THE DRAWINGS

The invention will be explained in greater detail below, based on several preferred exemplary embodiments depicted in the Figures.

FIG. 1 shows a partial cut-away, perspective view of a generic plug connection, that is, depicted without the inventive locking part provided thereon, in the inserted and locked state of the coupling parts,

FIG. 2 shows a perspective view of a first design of a plug connection according to the principles of the present invention, with the first design of the inventive retaining part, but wherein only one coupling part and the retaining part are illustrated in a preassembly state before insertion into a sleeve part,

FIG. 3 shows a top view of a first embodiment of a locking part according to the invention,

FIG. 4 shows an enlarged detail of FIG. 3,

FIGS. 5a to 5c show a top view in a depiction corresponding to FIG. 2, a longitudinal cross section and a transverse cross section of the first embodiment of a plug connection according to the principles of the present invention, still unlocked and with the first embodiment of a retaining part according to the invention,

FIGS. 6a to 6c show a top view, a longitudinal cross section and a transverse cross section of the first embodiment of a plug connection according to the principles of the present invention, still unlocked and with the first embodiment of a retaining part according to the invention, similar to FIGS. 5a to 5c, but wherein the coupling part is depicted after its insertion into a sleeve part,

FIGS. 7a to 7c show a top view, a longitudinal cross section and a transverse cross section of the first embodiment of a plug connection according to the principles of the present invention, and with the first embodiment of a retaining part according to the invention, similar to FIGS. 6a to 6c, but wherein the coupling part is locked,

FIG. 8, shows a perspective view of a second embodiment of a plug connection according to the principles of the present invention, with the second design of the inventive retaining part, but wherein only one coupling part and the retaining part are illustrated in a preassembly state before insertion into a sleeve part,

FIG. 9 shows a top view of a second embodiment of a locking part according to the invention,

FIG. 10 shows an enlarged detail of FIG. 9,

FIGS. 11a to 11c show a depiction corresponding to FIG. 8, showing a top view, a longitudinal cross section and a transverse cross section of the second embodiment of a plug connection according to the principles of the invention, still unlocked, and with the second embodiment of a retaining part according to the invention,

FIGS. 12a to 12c show a top view, a longitudinal cross section and a transverse cross section of the second embodiment of a plug connection according to the principles of the present invention, still unlocked, and with the second embodiment of a retaining part according to the principles of the present invention, similar to FIGS. 11a to 11c, but wherein the coupling part is depicted after its insertion into a sleeve part,

FIGS. 13a to 13c show a top view, a longitudinal cross section and a transverse cross section of the second embodiment of a plug connection according to the principles of the present invention, and with the second embodiment of a retaining part according to the invention, similar to FIGS. 12a to 12c, but wherein the coupling part is locked,

FIGS. 14a to 14c each show depictions of a cross sectional illustration of a third embodiment of the inventive plug connection and of a retaining part according to the principles of the present invention, wherein the plug connection in FIG. 14a is shown in a position like that in FIG. 5c, FIG. 14b is shown in a position like that in FIG. 6c, and FIG. 14c is shown in a position like that in FIG. 7c.

FIGS. 15a and 15b each show depictions of a cross sectional illustration of a fourth embodiment of the inventive plug connection and of a retaining part according to the principles of the present invention, wherein the plug connection in FIG. 15a is shown in a plugged and locked position like that in FIG. 13c, and FIG. 15b shows a detail of the locking part,

FIG. 16 shows an enlarged detail of FIG. 5b,

FIG. 17 shows an enlarged detail of FIG. 5c,

FIG. 18 shows an enlarged detail of FIG. 11c (top half of the Figure)

FIG. 19 shows an enlarged detail of FIG. 11b (top half of the Figure)

FIG. 20 shows an enlarged detail of a half-inserted, intermediate state of the inventive plug connection between FIG. 5b and FIG. 6b (top half of the Figure)

FIG. 21 shows an enlarged detail (top half of the Figure) of a half-inserted, intermediate state of the inventive plug connection between FIG. 5c and FIG. 6c (top half of the Figure),

FIG. 22 shows a depiction as in FIG. 20, but with dimensional information,

FIG. 23 shows an enlarged detail of a fully inserted, intermediate state of the inventive plug connection, analogous to the state according to FIG. 6b (top half of the Figure),

FIG. 24 shows an enlarged detail of a fully inserted state of the inventive plug connection, analogous to the state according to FIG. 6c (lower half of the Figure),

FIG. 25 shows an enlarged detail of a fully inserted state of the inventive plug connection, analogous to the state according to FIG. 6b (lower half of the Figure),

FIG. 26 shows an enlarged detail of a fully inserted and locked state of the inventive plug connection, analogous to the state according to FIG. 7c (lower half of the Figure),

FIG. 27 shows an enlarged detail of a fully inserted and locked state of the inventive plug connection, analogous to the state according to FIG. 7b (lower half of the Figure).

### DETAILED DESCRIPTION

With regard to the subsequent description it is expressly asserted that the invention is not restricted to all or to several features of described feature combinations. Rather, each individual partial feature of the exemplary embodiment is individually inventive, detached from all other parts and features described in connection with it, and also in combination with other features, and also independently of the feature combinations and back-relationships, and has an inventive significance.

The same and/or mutually corresponding parts in the various Figures and drawings are always depicted with the same reference numbers and, thus, generally need be described only once.

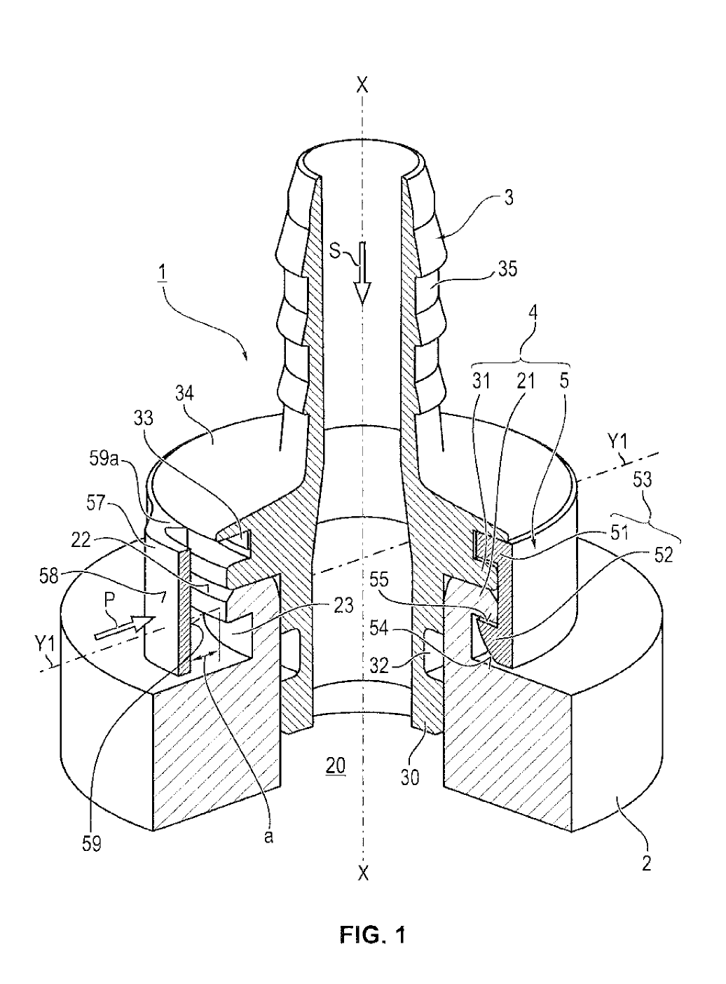

A plug connection 1 according to the invention, which can be used in particular for the connecting of fluid lines, comprises two coupling parts 2, 3 which can be plugged together and are inserted into each other in the assembled state depicted in FIG. 1 and in this state are releasably locked by a locking device 4 coaxially adjacent to each other. The two coupling parts 2, 3 which can be plugged together pertain in particular to a sleeve part 2 and to a coupling part 3, which can be inserted axially (axis X-X) by its coupling shaft 30 into a receiving opening 20 (depicted only in FIG. 1) of the sleeve part 2 and in the inserted state is held securely by the locking device 4. The two coupling parts 2, 3 can both preferably be designed from plastic.

The locking device 4 is comprised firstly of two outer, radial, flange-like retaining webs 21, 31 of the two coupling parts 2, 3. In the inserted state, these retaining webs are axially adjacent to each other in the insertion direction (arrow S). The locking device consists secondly of a retaining part 5. The retaining part 5 can be also designed as an injected molded plastic part, in particular for use at lower fluid pressures, and preferably a thermoplastic material can be employed.

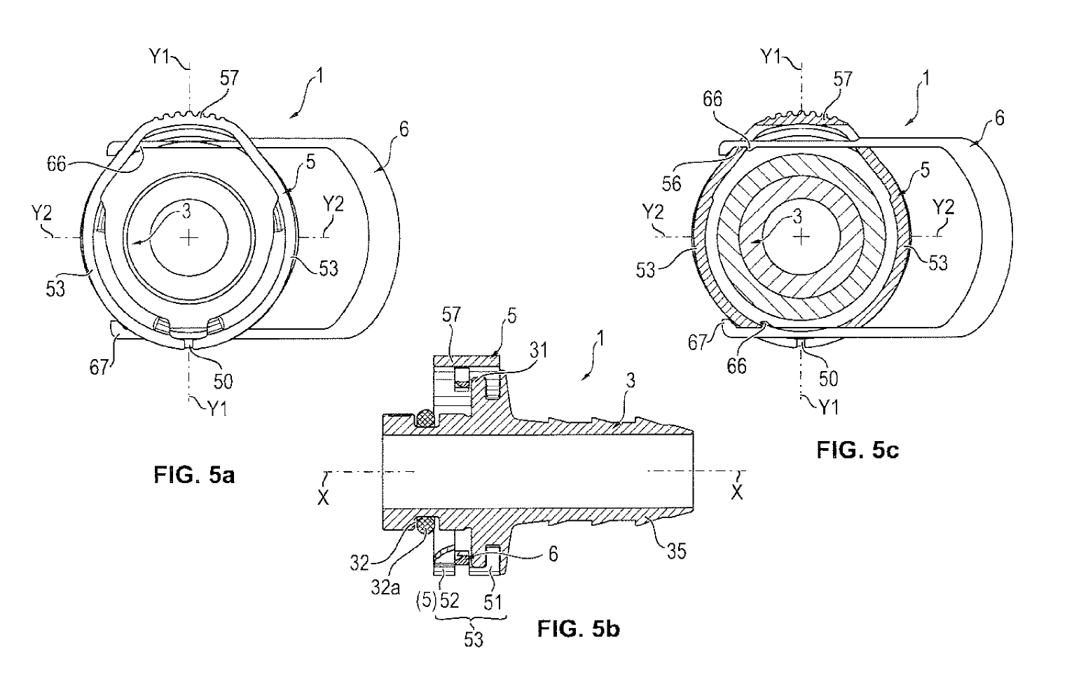

To seal the plug connection 1, preferably a ring groove 32 can be supplied on the coupling shaft 30, into which a perimeter seal 32a, especially in the form of a sealing ring, can be provided, as is depicted in FIGS. 5b, 6b, 7b, 11b, 12b and 13b.

The retaining part 5 can feature either an open ring contour, interrupted by a slit 50 (not otherwise depicted) on the perimeter, like that indicated in particular in FIGS. 5a, 5c, 6a, 7a, 11a, 11c, 12a, 12c, or also a closed, ring contour. In a preassembly state shown in FIG. 2 for the first embodiment, or as shown in FIG. 8 for the second embodiment, the retaining part 5 can be axially and radially affixed in a non-loss manner to one of the two coupling parts 2, 3—in the illustrated embodiments, to the coupling part 3.

Basically the retaining part 5 is designed as a one-part, elastic ring clamp which preferably features an enclosed, ring shape to promote the radial elastic deformability in a perimeter region of the axial and radial slit 50 which serves as an interruption of a closed ring shape, so that preferably two spring-elastic, bow-shaped snap-in arms are formed. The snap-in arms, or in the case of an enclosed ring contour, the lateral perimeter regions of the ring clamp, each form at least one C-shaped retaining section 53 and/or feature one such retaining section. Thus the retaining part 5 can be mounted and dismounted transverse to the insertion axis X-X under elastic expansion.

For the assembly, beginning from the preassembly state, first the retaining part 5 undergoes a spring-elastic expansion, then is pulled over the other, non-preassembled coupling part 2, and a subsequent spring-elastic back-deformation occurs. The anti-loss property of the retaining part 5 is defined firstly by its either closed, or only slightly opened ring shape, which owing to the small slit width of the slit 50, deviates only a little from an enclosed ring shape. The slit width of the slit 50 can be in particular a slit opening angle, whose legs extend from the end of the retaining part 5 lying between the two sides of the slit 50 and are not described in detail, and have their apex point in the plug axis X-X, which in particular is smaller than 15°, preferably is smaller than 5°

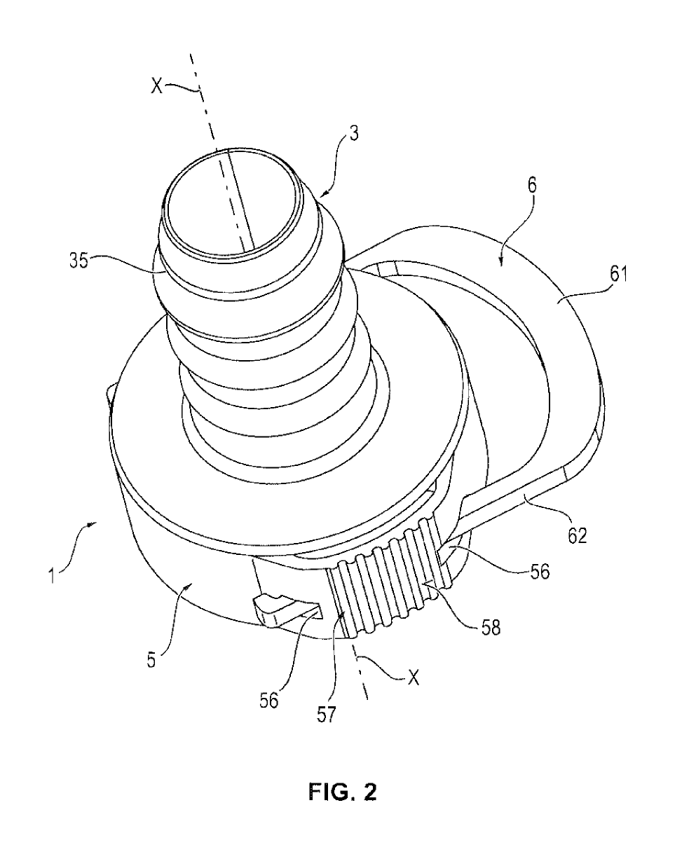

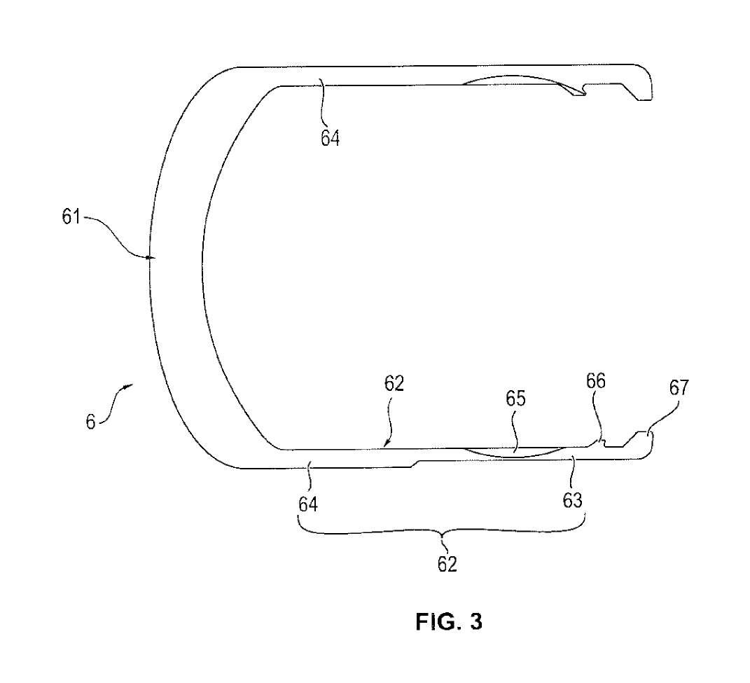

From the illustrations of the retaining part 5, especially those in FIGS. 1, 5b, 6b, 7b, 11b and 12 showing the preassembly and assembled states, it is evident that the retaining part features at least one C-shaped (axial cross section) retaining section 53 moveable in a radial elastic manner and features two collars 51, 52. After the assembly the retaining webs 21, 31 of the two coupling parts 2, 3 axially and radially surround the retaining section in a friction fit. Preferably two such retaining sections 53 are provided, which rest symmetrical to a longitudinal axis Y1-Y1 of the retaining part 5. The formation of the collars 51, 52 of the retaining section 53 to be described below also contributes to the anti-loss property of the retaining part 5. Or stated differently, the collars 51, 52 pertain to ring collar sections provided on the perimeter, but as a simplification they will be designated hereinafter simply as “collars.” In all the illustrated embodiments, two retaining sections 53 are provided, each symmetrical with respect to a longitudinal axis Y1-Y1 of the retaining part 5 depicted in FIGS. 3 to 8, and diametrically opposite each other on a transverse axis Y2-Y2, but wherein a greater number of retaining regions could be present to provide an optional, perimeter segmenting of the retaining sections 53.

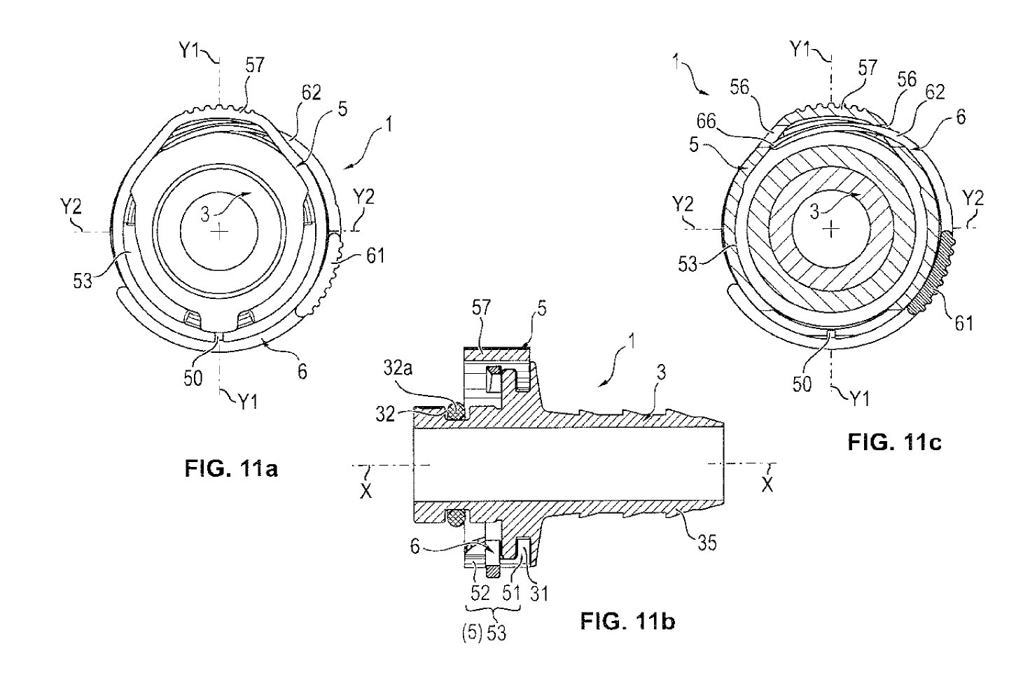

The second collar 52 of each retaining section 53 of the retaining part 5—as depicted especially only in FIG. 1—is designed preferably as a snap-in element with a radial interior slant surface 54, which can be preferably convex and be positioned on the side facing the sleeve part 2 in the insertion process. When the coupling part 3, to which the retaining part 5 (FIGS. 5a to 5c, figures 11a to 11c) is preassembled for the assembly, and such assembly is effected by a snap-in connection, is inserted along the axis X-X in the coupling direction S into the receiving opening 20 of the sleeve part 2, this slant surface 54 acts as a spreader surface for the retaining part 5 and/or more precisely, for its second collar 52.

For a preassembly locking of the retaining part 5, the associated coupling part 2, 3, preferably the coupling part 3, can have an additional locking bar 34, as depicted in FIGS. 5a to 5c and 11a to 11c, to form a perimeter groove 33 which accommodates the corresponding, radial collar 51 of the retaining part 5. For the sake of conciseness, the perimeter groove 33 and the additional locking bar 34 are provided with reference numbers only in FIG. 1. The locking bar 34 preferably can have a diameter greater than the diameter of the retaining web 31. The diameter of the retaining web 31 instead corresponds preferably to about the interior diameter of the retaining region 53 in an interior surface region between the collars 51, 52.

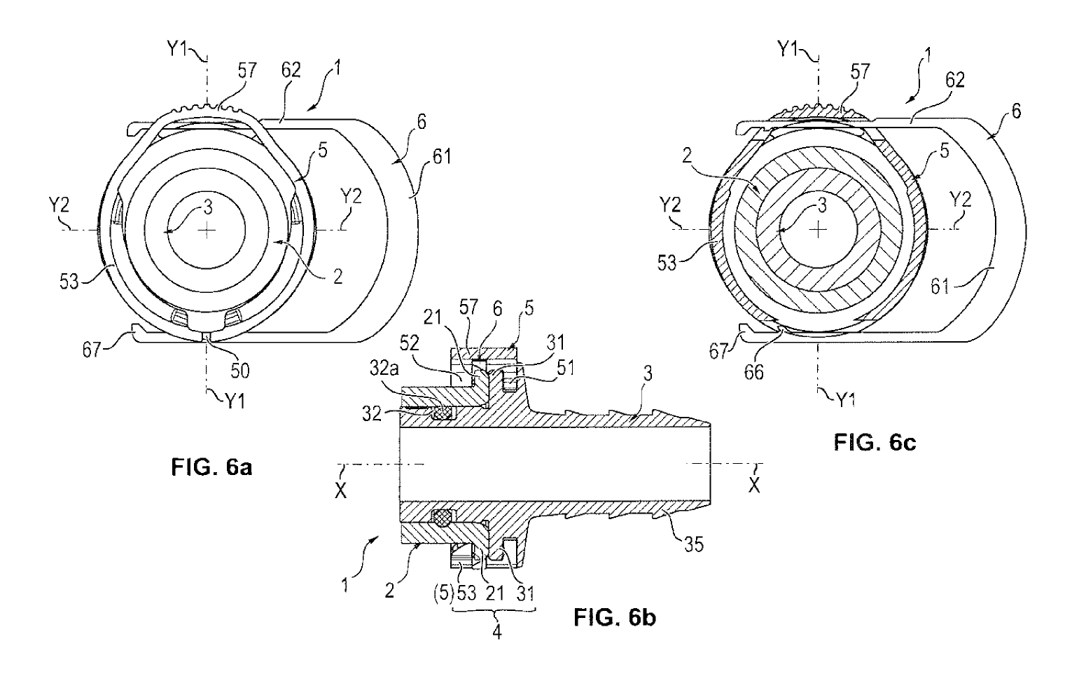

Since the spreader surface 54 slides relative to an opposing spreader surface 22 of the retaining web 21 acting as opposing snap-in element, under the effect of an assembly force during the coupling, this causes a radially outwardly directed spreading movement of the retaining part 5 transverse to the axis X-X. After reaching the end of the spreading path, a radial retaining edge 55 of the collar 52 positively engages with the retaining web 21 of the sleeve part 2, so that a positive snap-in connection acting in the coupling direction S is formed, like that depicted in FIG. 1, and also in FIGS. 6a to 6c, 7a to 7c, 12a to 12c and 13a to 13c. Upon coupling of the coupling parts 2, 3 together, the retaining section 53 is moved radially outward due to the retaining web 21 moving relative thereto, and after a subsequent, radial back movement inward, it engages the retaining webs 21, 31 of the two coupling parts 2, 3 locking them in a C-shape in the inserted state. The collars 51, 52 of the particular retaining section 53, as shown in the reference figures, in the assembled state positively engage the shaft 30 of the coupling part 3, preferably in the region of the perimeter groove 33 of the coupling part 3, and positively engage the sleeve part 2 beneath its retaining web 21, that is, on the side facing away from the coupling part 3, preferably in the region of a perimeter groove 23 of the sleeve part 2.

In one preferred embodiment, for the inventive plug connection 1 and/or for the inventive retaining part 5, the invention provides that the collars 51, 52 in the retaining section 53 of the retaining part 5 are designed with a different size and/or shape, such that given a radial elastic movement of the retaining section 53 from the assembled state outward, a collar 52, which in the assembled state rests against the retaining web 21 of the one coupling part 2, releases this retaining web 21 of the coupling part 2, whereas the other collar 51, at least in regions, still engages with the retaining web 31 of the other coupling part 3 against which it rests. In this respect the invention provides that the two collars 51, 52, viewed from above, are of equivalent design only in regions, and in particular are preferably not congruent. In particular, they can have different wrap-around angles for the coupling part 2, 3 located between them, and thus have a different perimeter length—while having roughly the same width and equivalent, or preferably the same, consistent, circular-shaped curvature.

The radial elastic movement of the retaining section 53 outward from the assembly state occurs according to the invention preferably in the presence of at least two retaining sections 53, which are positioned symmetrical to the longitudinal axis Y1-Y1 of the retaining part 5, in whose plane the slit 50 of the retaining part 5 is located. The retaining sections 53 here execute a tongs-like spreader movement against each other, and the slit opening angle between the ends of the retaining part 5 on both sides of the slit 50, is enlarged.

At the transverse sides of the retaining part 5, on the perimeter there is an elastic—at least in regions—actuation region 57 located between the collars 51, 52 of the retaining sections 53. Due to a manual pressure on one pressure surface 58 (pressure arrow p in FIG. 1), preferably with only one finger, during the disassembly due to the spreading, a radial expansion of the retaining sections 53 can be effected, which is sufficient to extract one coupling part 2, 3—in the present case, sleeve part 2—axially from the plug connection 1. This means that the mutual spacing between the lower collars 52 located opposite each other with respect to the longitudinal axis Y1-Y1 of the retaining part 5, is enlarged sufficiently such that it is greater than the diameter of the retaining web 21 of the coupling part 2. The mutual spacing between the upper collars 51 located opposite each other with respect to the longitudinal axis Y1-Y1 of the retaining part 5, in contrast will be enlarged only enough so that it is still smaller than the diameter of the retaining web 31 of the coupling part 3.

The actuation region 57 in the illustrated embodiment begins at the perimeter end of the one retaining section 53 and ends at the perimeter end of the opposing retaining section 53. Whereas the retaining part 5 in the region of the actuation region 53 has a cylindrical (circular-shaped in cross section) outer contour interrupted by the slit 50, the actuation region 57 extends tube-like away from this outer contour, and the pressure surface 58 rests upon a perimeter which limits the radial install size of the invented retaining part 5. In the case of an enclosed contour—that is, in the case that no slit 50 is provided—instead of the slit 50, an equivalent actuation region 57 could be provided.

An interior wall region 59 of the retaining part 5, which is opposite the pressure surface 58 in the actuation region 57, can preferably form a stop, and if it is moved along an actuation path a in the direction of the longitudinal axis Y1-Y1 of the retaining part 5, at the end of the disassembly process it comes to rest against the coupling part 3, in particular against its shaft 30, more specifically against the retaining web 31 of the shaft 30. Pressing of the actuation region 57 against the retaining web 31, leads firstly to the spreading of the retaining sections 53, simultaneously with the spreading of the retaining sections 53, under the effect of the pressure force p, a displacement of the retaining part 5 occurs radially inward along its longitudinal axis Y1-Y1, and the actuation region 57 is elastically deformed. The radially inward displacement of the retaining part 5 is continued until—as already mentioned—the mutual spacing along the transverse axis Y2-Y2 between the lower collars 52 (located opposite each other with regard to the longitudinal axis Y1-Y1) of the retaining part 5, becomes so large that it is greater than the diameter of the retaining web 21 of the sleeve part 2. Then the sleeve part 2 can be removed from the coupling part 3 and extracted in the axial direction X-X from the inventive plug connection 1. Because the mutual spacing on the transverse axis Y2-Y2 between the upper collars 51 located opposite each other with respect to the longitudinal axis Y1-Y1 of the retaining part 5 is still smaller than the diameter of the retaining web 31 of the coupling part 3, the retaining part 5 is thus held securely against the coupling part 3.

After cessation of the applied pressure force p, the retaining part 5 moves due to an elastic spring-back motion of its retaining sections 53 in a simple manner into a position as it was in before the deformation. Provided the sleeve part 2 was removed, the preassembly state is thus restored.

With regard to the preassembly mounting of the retaining part 5 (FIGS. 5a to 5c and 11a to 11c) it should also be remarked that after an axial pushing of the one-part retaining part 5 onto the coupling part 3, its retaining regions 53 will snap onto the coupling part 3 due to a friction-locked radial motion, so that the retaining part 5 is maximally spread apart in the region of its retaining regions 53.

In one favorable embodiment of the invention, which is illustrated particularly well by FIG. 1, control and stabilization cams 59a are provided in the region of the actuation region 57 of the retaining part 5 emanating from the inner wall region 59 and pointing radially inward. These control and stabilization cams 59a rest preferably in the plane of the upper collars 51 and during the disassembly they each slide in the perimeter groove 33 to receive the upper collars 51 which are between the retaining web 31 and the locking bar 34 of the coupling part 3. The control and stabilization cams 59b perform the function of ensuring that the retaining part 5 is not displaced in the axial direction X-X of the plug connection 1 during the disassembly.

In order to secure the retaining part 5 in the assembled state against accidental or unintentional release of the plug connection 1, the invention provides that a locking part 6 is arranged and designed such that it is moveable transverse to the axial coupling direction S of the coupling parts 2, 3 from a release position into a locking position, wherein the locking part 6 in the release position releases a radial movement of the retaining part 5 from its assembled state, and in the locking position prevents a radial movement of the retaining part 5 from its assembled state. To secure the connection, the locking part 6 is disposed in a loss-proof manner, especially on the retaining part 5. For this purpose, it can be positioned in particular in the free space, namely, in the actuation path a in the direction of the longitudinal axis Y1-Y1 of the retaining part 5 between the actuation section 57 and the retaining collars 21, 31.

Thus the movement of the actuation section 57 in a radial direction (arrow p in FIG. 1) is blocked and an opening of the connection is prevented.

In an advantageous manner the locking part 6 can only be actuated when the coupling process is completed—as will be described below.

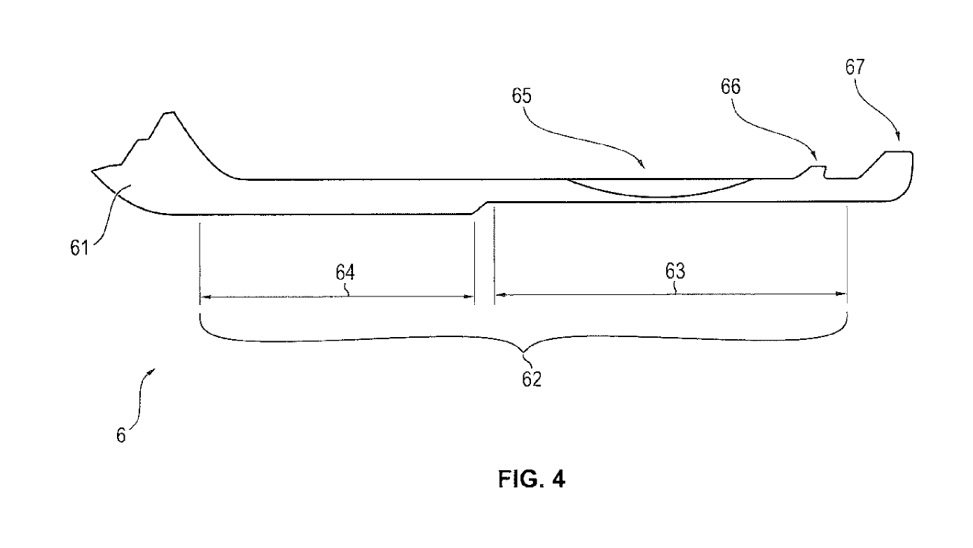

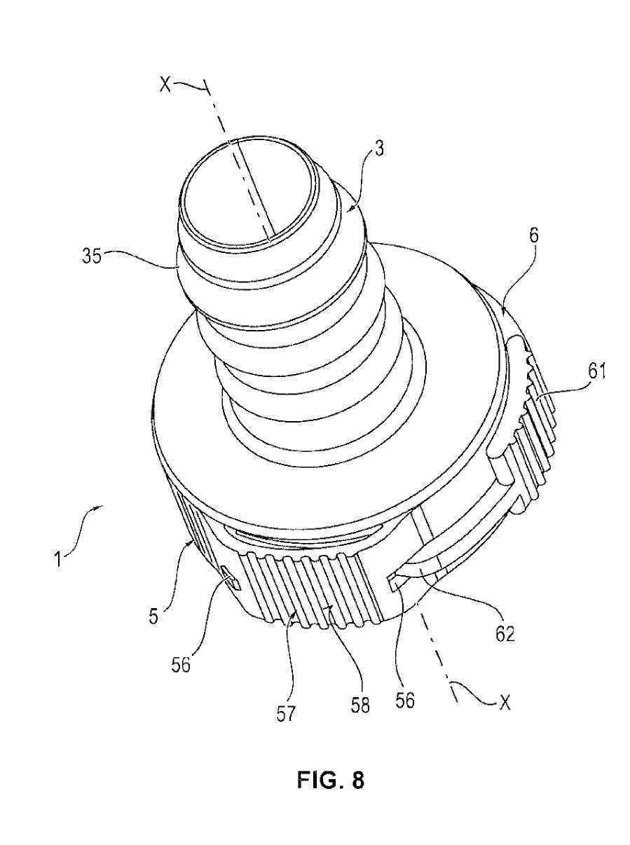

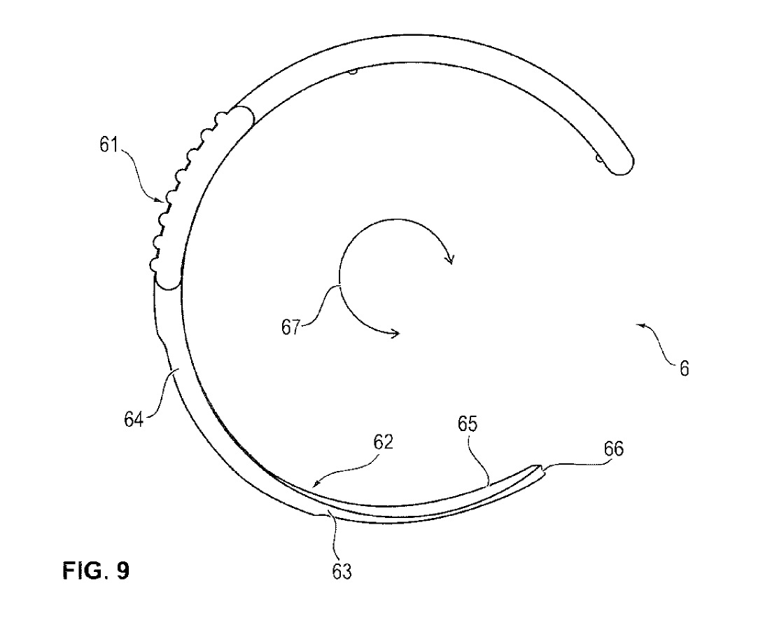

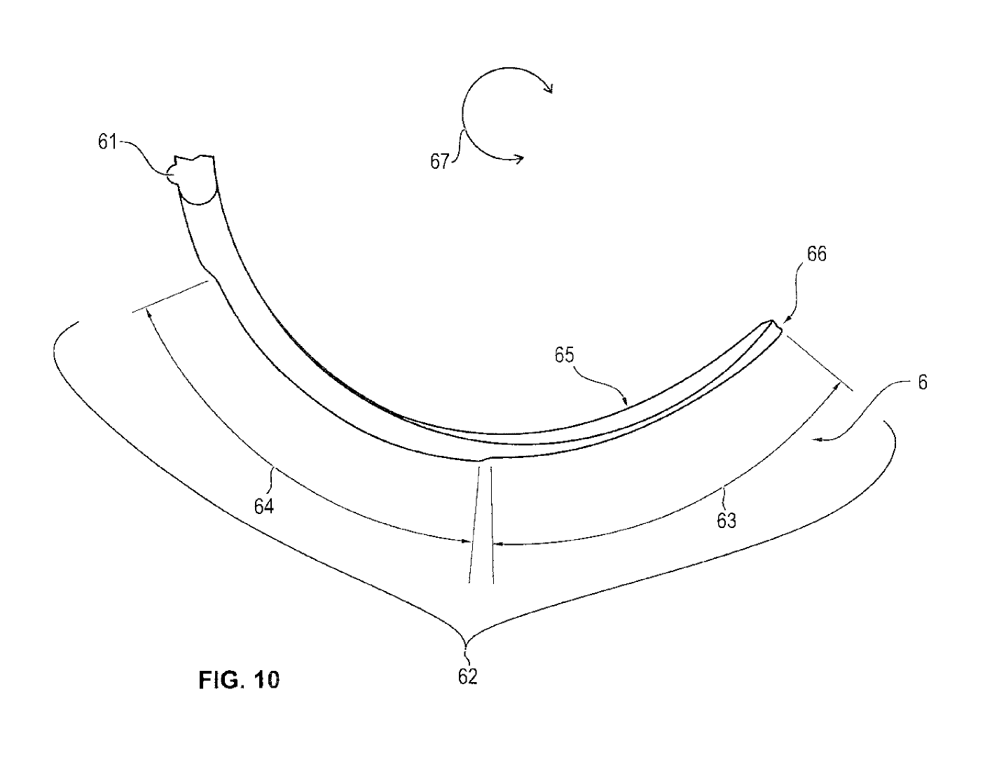

FIGS. 2 to 7c pertain to a first embodiment of the locking part 6, and FIGS. 8 to 13c pertain to a second embodiment. The first embodiment pertains to a fundamentally U-shaped structure—viewed from above—of a locking part 6, hereinafter denoted as the “transverse lock,” and which moves from its release position into the locking position due to a radial insertion into the retaining part 5. The transverse lock is depicted in FIG. 3 as a single part, and FIG. 4 depicts an enlarged detail. The second embodiment pertains to a C-shaped structure—viewed from above—of a locking part 6, hereinafter denoted as the “rotary lock,” and which moves from its release position into the locking position due to a circumferential turning into the retaining part 5. The rotary lock is depicted in FIG. 9 as a single part, and FIG. 10 depicts an enlarged detail.

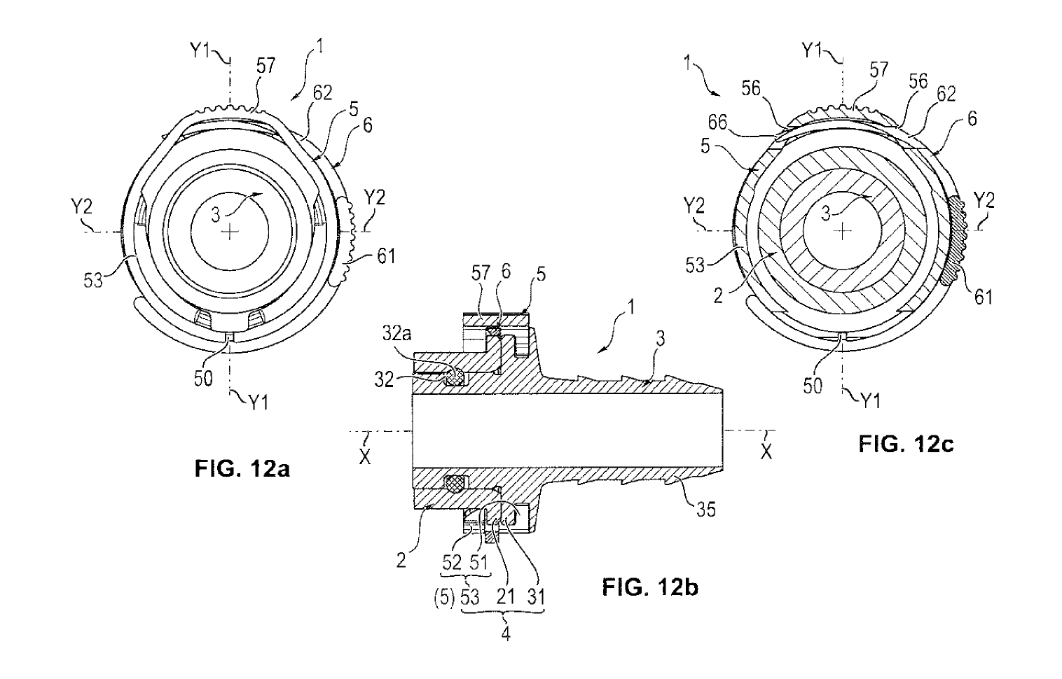

Both designs presume that at least one window 56 is present in the retaining part 5, through which the locking part 6 can be introduced into the retaining part 5. From FIGS. 2 and 8 it is evident that there are two windows 56 provided in the retaining part 5, and specifically on both sides of the actuation region 57 of the retaining part 5. In both embodiments (FIGS. 2, 5a to 5c, 6a to 6c, 7a to 7c, and also FIGS. 12a to 12c and also 13a to 13c) the one window 56 serves as entry window and the other window 56 serves as exit window, either for the transverse lock or for the rotary lock.

The locking part 6 in both embodiments has at least one actuation section 61 and one locking arm 62. By application of a pressure force onto the actuation section 61, the transverse lock can be moved radially into a locking position. With the rotary lock, the same result occurs through application of a rotary torque and/or of a tangential force onto the actuation section 61.

The locking arm 62 in both embodiments features a radially moveable, elastic section 63 and a blocking section 64. The radially moveable elastic section 63 is a terminal-positioned section of the locking arm 62, which is displaced radially outward during the coupling process through the retaining collar 21 of the coupling part 2 to be connected, in the present case, the sleeve part 2. FIG. 3 depicts that the locking arm 62 of the transverse lock illustrated therein can have a smaller cross section than the other leg of the U of the locking part 6. The locking part 6 thus has an asymmetrical design.

The blocking section 64, which is located between the elastic section 63 and the actuation section 61, pertains to a reinforced section of the locking arm 62, which is positioned in the locking position between the actuation section 57 of the retaining part 5 and the retaining collar 21 of the coupling part 2, to which the retaining part 5 is not preassembled; in the illustrated case, this is the sleeve part 2.

In the preferred design of both embodiments of the locking part 6, one insertion slant surface can be provided on each locking arm 62, which are each designated in FIGS. 3 and 4, and also FIGS. 9 and 10, by reference number 65. The retaining collar 21 of the coupling part 2 to be inserted, moves in an axial direction along this insertion slant surface 65 and displaces the radially moveable section 63 of the locking arm 62 in a radially outward manner.

Furthermore, in a likewise preferred design of the two embodiments of the locking part 6, means can be provided on the locking arm 62 to implement a coupling control 66.

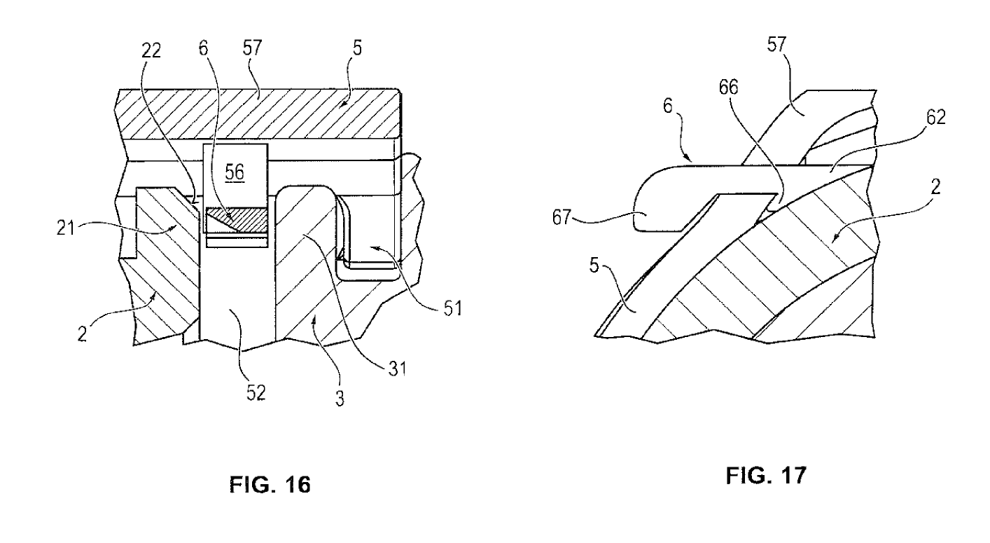

In this regard a cam is formed in a region of the transverse lock (FIGS. 3, 4) between the free end of the locking arm 62 and the insertion slant surface 65 as means to implement a coupling control 66. If the coupling is incomplete, this cam is braced against the wall of the retaining part 5, and specifically against the side and/or against the window 56 on which or from which the locking arm 62 again emerges from the retaining part 6 underneath the actuation region 57, that is, resting radially inward, as is illustrated in particular in FIGS. 5a and 5b. Thus any insertion of the transverse lock is prevented as long as the cylindrical sections of the lock and retaining collar 21 do not come together. In this regard refer also to the enlarged representations in FIGS. 16 and 17. From FIG. 17 in particular it is clear that the cam as a means to implement a coupling control 66 is not free in the preassembly state.

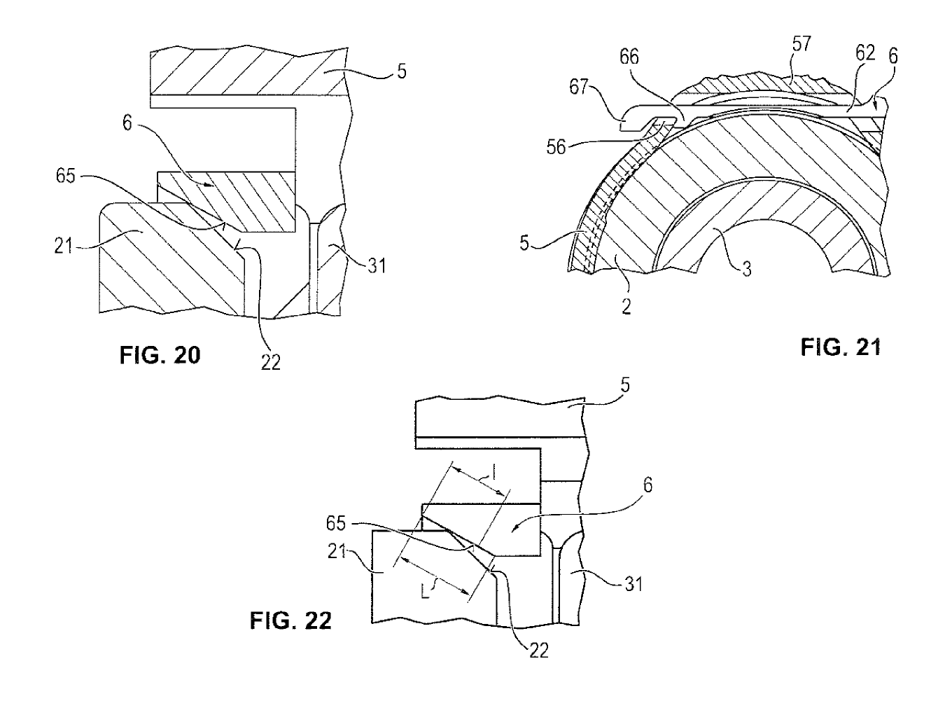

When coupling the coupling parts 2, 3 together, the transverse lock is then spread apart radially due to the retaining collar 21 of the coupling part 2, and thus lifts the cam of the coupling control 66 past the stop at the window 56 of the retaining part 5. In this regard refer also to the enlarged illustrations in FIGS. 20 to 22, which depict a half-coupled, intermediate state of the inventive plug connection 1. Only once it is assured that the collar 52 of the retaining part 5 has snapped in behind the retaining collar 21 of the coupling part 2 being inserted, thus when the invented plug connection 1 is fully inserted, can the locking part 6 be moved. Only then is the transverse lock released for insertion into its locking position.

The insertion slant surface 65 of the particular lock can be designed as a complementary insertion slant surface 22 of the web 21 of the coupling part 2, such that the locking part 6 can be rotated or pushed into the locking position only when the plug connection 1 is fully snapped in, this means, only when the cylindrical sections of lock and retaining collar 21 come together. As an example, FIG. 22 illustrates that in the half-inserted, intermediate state, the edge of the opposing spreader surface 22 of the retaining collar 21 of the coupling part 2 has slipped along a slide path of at least I=75 (up to 100) percent along the length L (=100 percent) of the insertion slant surface 65 of the locking part 6.

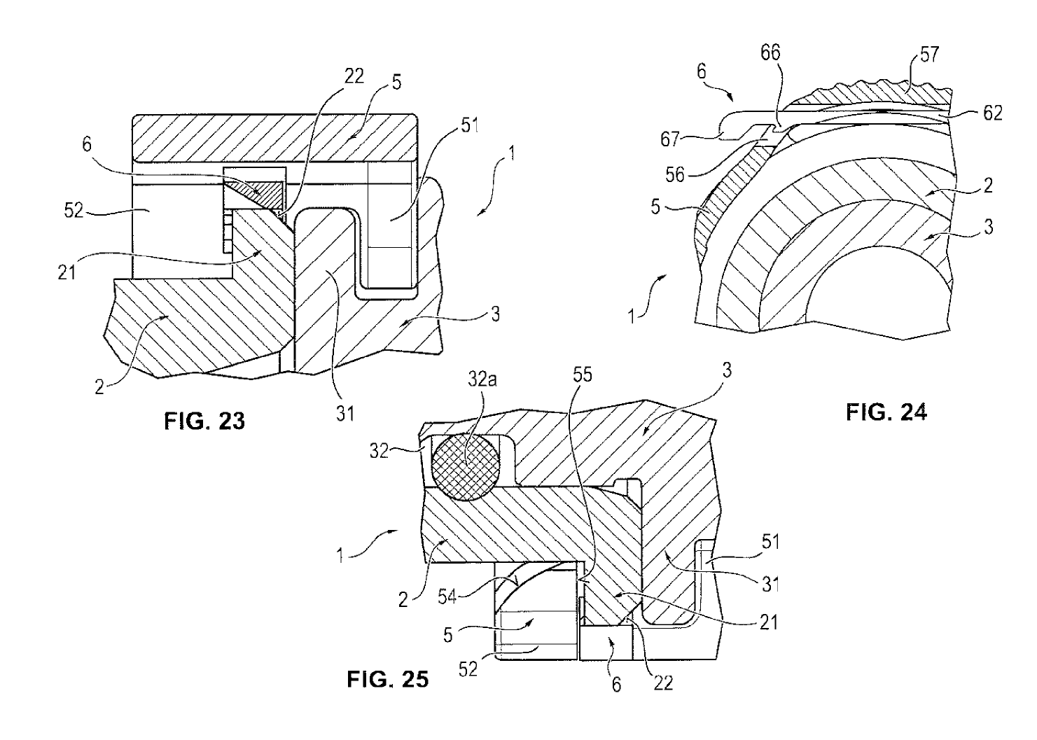

From the supplemental, enlarged illustrations in FIGS. 23 to 25, which pertain to the coupled, but not yet locked assembly state of the invented plug connection 1, as is also depicted in FIG. 1—but without the locking part 6—it is clear that the collar 21 of the coupling part 2 to be inserted has displaced the locking part 6 radially outward (FIG. 23) far enough so that after the coupling, the cam of the locking part 6 acting as means to implement the coupling control 66 can pass through the window 56 of the retaining part.

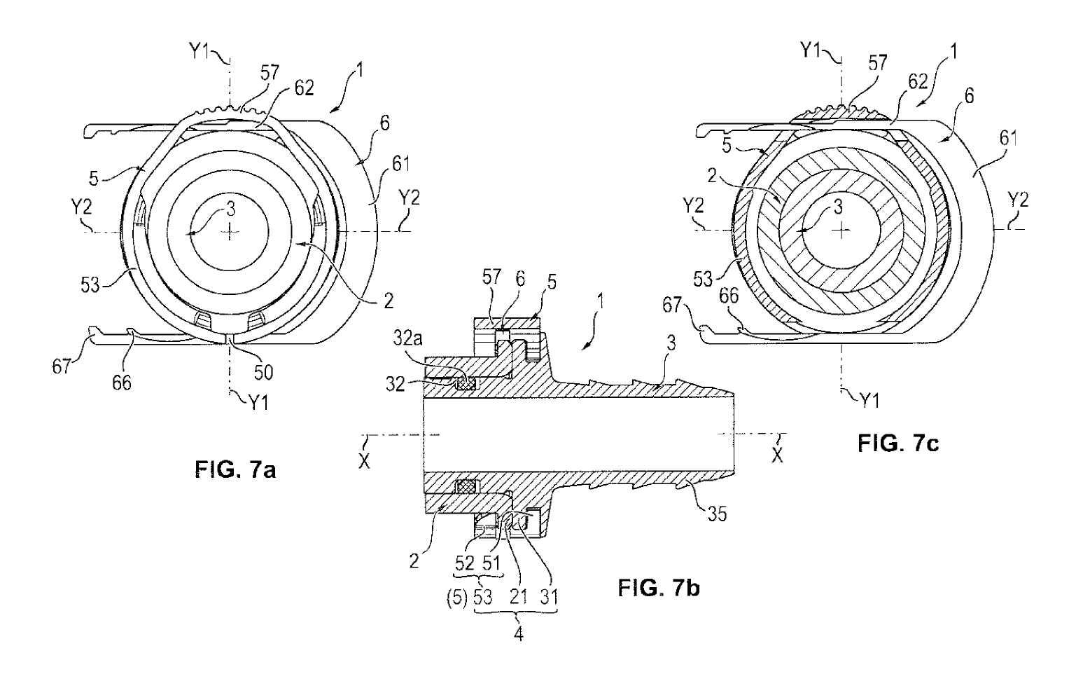

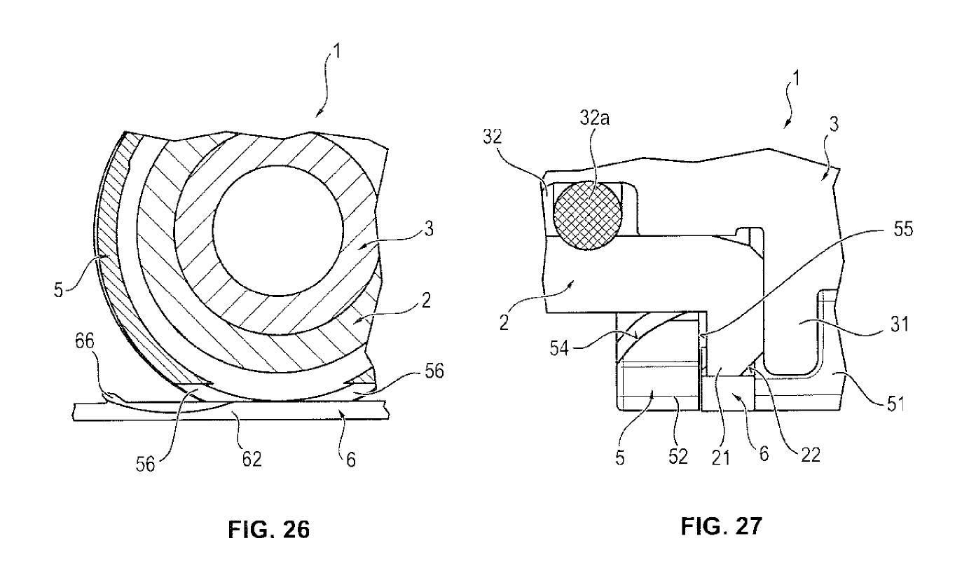

After this, the locking can occur, as is shown in FIGS. 7a to 7c. In this regard refer also to the enlarged representations in FIGS. 26 and 27, which very clearly indicate in particular the location of the locking part 6 in the invented plug connection 1 and in the invented retaining part 5.

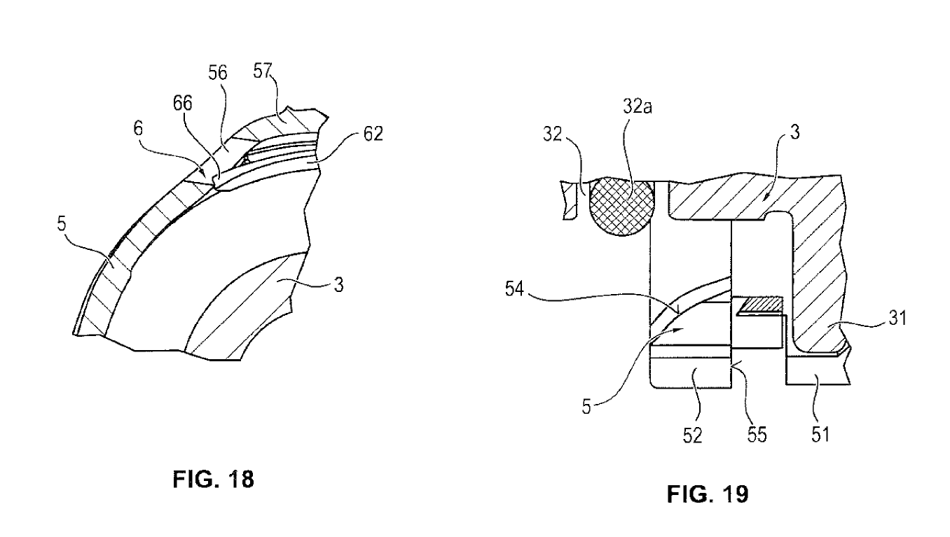

In the case of the rotary lock (FIGS. 9, 10) the free end of the locking arm 62 is itself designed with a cam-shape and in the case of an incomplete or not entirely completed plug connection 1, it is braced against the wall of the retaining part 5, against the side where the locking arm 62 emerges from the window 56—resting radially inward from the actuation section 57—and thus can act as a means to implement a coupling control 66, because an additional rotation of the rotary lock is prevented as long as the cylindrical sections of the rotary lock and retaining collar 21 do not rest one upon the other. This is very clearly depicted in FIGS. 18 and 19, which are additions to FIGS. 11a to 11c. From FIG. 18 it is evident that the means to implement a coupling control 66 is not free in the preassembly state, whereas FIG. 19 (enlarged representation of the partly cut-away, lower region of the preassembled, inventive plug connection 1 in FIG. 11b) illustrates that the collar 52 of the retaining part 5 is not engaged.

When coupling the coupling parts 2, 3 together, the rotary lock is spread apart radially by the retaining collar 21, which detaches by its cam-like end 66 from the stop at the retaining part 5, and thus enables an additional rotation of the coupling part. With respect to this process, refer in particular to a comparison of FIG. 11c with FIG. 12c, which illustrates this process quite clearly.

The means to implement a coupling control 66 thus represents a detachable locking means which blocks the movement of the locking part 6 in the release position against any movement into the locking position, as long as a complete and correct coupling of the coupling parts 2, 3 has not occurred.

Finally, in yet another preferred embodiment—as is illustrated especially in FIGS. 3 and 4, and in FIGS. 9 and 10—anti-loss means 67 can be provided on the locking arm 62 in both embodiments of the locking part 6. The anti-loss means 67 of this kind in the case of the transverse lock can be an end cam which is located in an end position at the free end of the locking arm 62, and when the transverse lock is not pushed into the retaining part 5, it is braced externally against the retaining part 5, so that the lock cannot fall accidentally out of the retaining part 5.

In the case of the rotary lock, this anti-loss means 67 is defined by the C-shaped configuration (when seen from above) of the locking part 6 across more than half of its inherent diameter, so that the locking part 6 is held securely against the retaining part 5. The anti-loss means 67 configured in this manner is depicted in FIGS. 9 and 10 by the circular-shaped, double arrow denoted by reference number 67.

As already explained in the discussion above, the invention is not limited to the depicted and described exemplary embodiments, but rather encompasses all equivalent embodiments within the meaning of the invention. For example, in contrast to the depicted and described embodiments in which the retaining part 5 is preassembled on the coupling part 3 and consequently coaxially surrounds the coupling shaft 30, quite obviously also a corresponding preassembly of the retaining part 5 onto the sleeve part 2 can be provided. Thus likewise a stand-alone, inventive significance is attributed to a preassembled component comprised of a retaining part 5 designed according to the invention, and a coupling part 2, 3 as described for the invented plug connection 1.

In all illustrations, the rotary lock is depicted asymmetrically, with only one locking arm 62. But in one favorable embodiment, it can also be of symmetrical design. Then both arms will feature a blocking section 64, insertion slant surface 65 and means for coupling control 66. The advantage in this case is that—however the lock is introduced into the window 56—the correct positioning is always ensured. The transverse lock can likewise be of asymmetrical or preferably symmetrical design.

Furthermore, the coupling parts 2, 3 can feature fundamentally any kind of connecting elements on their sides opposite the plug connection side. In the illustrated embodiment, the coupling part 3 features a connecting spindle 35 for a fluid line (tube or hose). The sleeve part 2 does not have any special design, but can have a short screw-in tube, for example, but also at least one of the coupling parts 2, 3, such as preferably the sleeve part 2, can also be designed as concomitant (as a single piece) with certain aggregates.

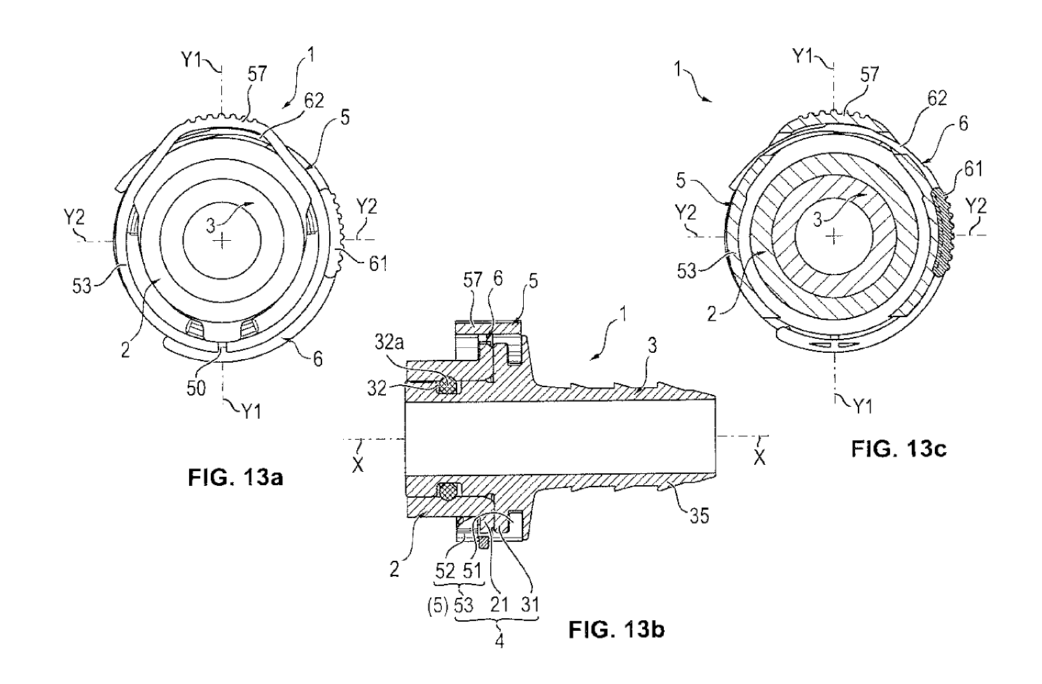

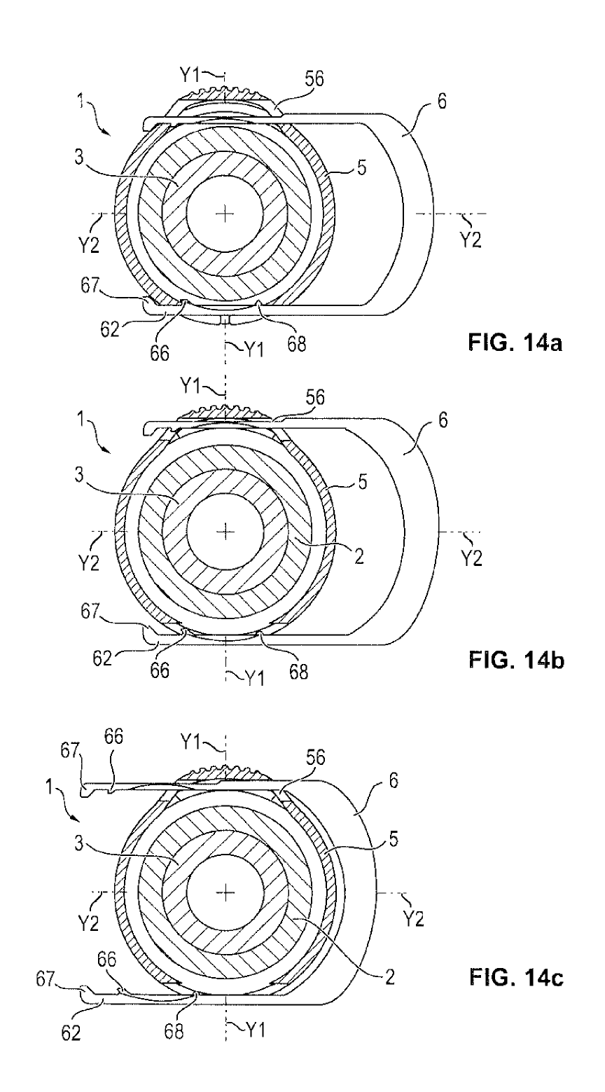

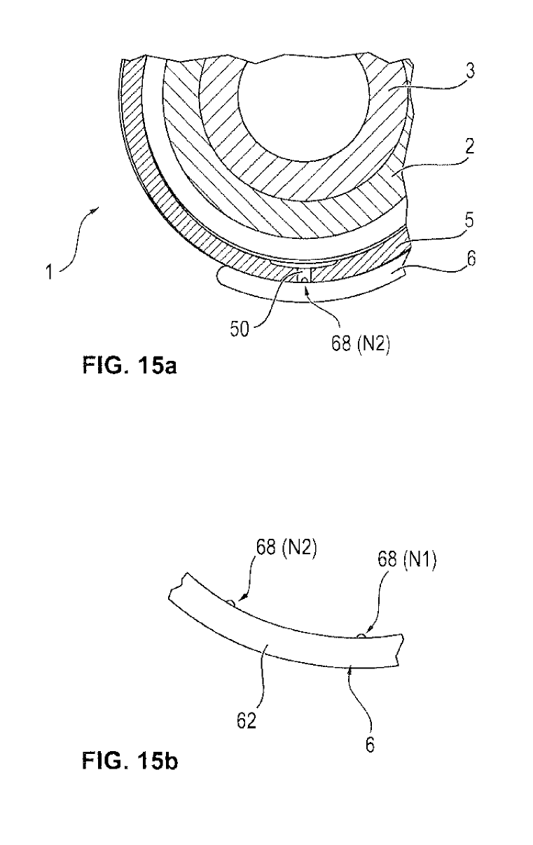

Furthermore, the person skilled in the art can undertake additional expedient modifications of the embodiment of the invention without leaving the scope of the invention. For example, it can be advantageous to provide an additional security 68 on the locking part 6 against accidental disconnecting or rotation of the locking part 6 from its locking position when in the assembled position of the invented plug connection 1 (FIGS. 7a to 7c and/or FIGS. 13a to 13c). The FIGS. 14a to 14c pertain to an additional favorable embodiment of an invented plug connection 1 with a transverse lock, and FIGS. 15a and 15b pertain to an additional, favorable embodiment of an invented plug connection 1 with a rotary lock. The specific design of the anti-extraction or anti-rotation lock 68 are different for the transverse and rotary locks.

As is indicated in FIGS. 14a to 14c, in the case of the transverse lock, which already has anti-loss means 67, an additional security cam is provided as pull-out security 68, which is braced against the inserted coupling part 2 and thus prevents the transverse lock from independently slipping out from its locked position.

As is indicated in FIGS. 15a and 15b, two anti-loss cams N1, N2 are provided on the rotary lock as extraction lock 68, and each of them snaps into the slit 50 of the retaining part 5. The snap-in of the first anti-loss cam N1 occurs in the preassembly position of the lock (FIGS. 11a to 11c), whereas the second anti-loss cam N2 comes about in the locking position (FIGS. 13a to 13c).

Furthermore, the invention is not limited to the combinations of features defined in the independent claims, but rather can also be defined by any other particular combination of certain features of all the disclosed, individual features. This means that basically virtually any individual feature of the independent claims can be omitted and/or replaced by at least one individual feature disclosed elsewhere in the application. In this respect the claims are to be understood merely as an initial attempt at formulation of an invention.

1. A plug connection for fluid lines, the plug connection comprising: first and second coupling parts that can be plugged together in an axial plug-in direction and that can be releasably locked by a locking device, the locking device being comprised of a first outer radial retaining web of the first coupling part and a second outer radial retaining web of the second coupling part, first and second webs being axially adjacent in the plug-in direction in the plugged state, the locking device further including a retaining part having an annular contour and which can be assembled secured axially and radially on one of the first and second coupling parts in a pre-assembled state, the retaining part also having least one C-shaped retaining section with two collars, the C-shaped retaining section being radially movable in a spring-elastic manner, the retaining section engaging the first and second webs of the first and second coupling parts in an axial and radial manner in the assembled state, the locking device being further comprised of a locking part arranged on the retaining part and being moveable transversely to the axial plug-in direction between a release position and a locking position, wherein in the release position, the locking part allowing radial movement of the retaining part out of the assembled state, and wherein in the locking position, the locking part preventing radial movement of the retaining part out of the assembled state.

2. The plug connection according to claim 1, wherein the retaining part is a single piece , elastic ring having one of a closed perimeter or a perimeter interrupted by a slit, the elastic ring having two of the C-shaped retaining sections, the two C-shaped retaining sections being distributed radially symmetrical about the perimeter on longitudinal sides of the elastic ring.

3. The plug connection according to claim 1, wherein the first coupling part is an insertion part, and the second coupling part is a receiving part with a receiving opening, wherein the first coupling part includes an insertion shaft that is insertable into the receiving opening of the second coupling part.

4. The plug connection according to claim 1, wherein one of the collars is configured as a snap-in element, having a radially inward slanting surface as spreader surface on a side of the retaining part facing in the axial plug-in direction during the insertion process, such that the relative movement between one of the retaining webs and the collar configured as the snap-in element during insertion causes a radially outward directed spreading movement of the retaining part, wherein a radial retaining edge of the collar configured as a snap-in element latches over and makes a friction-tight snap-lock with the one of the retaining webs.

5. The plug connection according to claim 1, wherein the retaining part includes at least one actuation region configured to spread and radially move in a spring-elastic manner the retaining sections, when a release force is applied in the radial direction upon the actuation region.

6. The plug connection according to claim 5, wherein the retaining part including the perimeter interrupted by a slot and the actuation region is spring-elastic actuation region extending circumferentially between the two retaining sections, the activation region being provided on a transverse side of the retaining part located diametrically opposite the slot, wherein the release force applied for the disassembly is a pressure force acting along a longitudinal axis of the retaining part onto a pressure surface of the actuation region and this pressure force causes the radial spreading of the retaining sections.

7. The plug connection according to claim 1, wherein the collars of the retaining section in the assembled state engage in a positive-locking manner around the first coupling part in a perimeter groove of the first coupling part, and engage in an interference-fit-locking manner around the second coupling part in a perimeter groove of the second coupling part.

8. The plug connection according to claim 1, wherein the collars are different in at least one of size and shape in that one of the collars in the assembled state surrounds one of the coupling parts across a larger central angle than a central angle by which the other of the collars surrounds the other of the coupling parts.

9. The plug connection according to claim 5, wherein the actuation region forms a stop which is configured to come to rest against one of the a retaining webs after transiting of an actuation path thereby limiting outward spreading motion of the retaining part and radial elastic motion of the retaining section.

10. The plug connection according to claim 5, wherein the locking part includes a blocking section configured to prevent radial movement of the retaining part from the assembled state, the blocking section being positioned in a free space between the actuation section and the retaining collars when the locking part is in the locking position.

11. The plug connection according to claim 1, wherein the locking part is a U-shaped transverse lock and is configured to move radially into the retaining part from the release position into the locking position.

12. The plug connection according to claim 11, wherein the transverse lock is one of asymmetrical and symmetrical.

13. The plug connection according to claim 1, wherein the locking part is a C-shaped rotary lock and is configured to rotationally move into the retaining part from the release position into the locking position.

14. The plug connection according to claim 13, wherein the rotary lock is one of symmetrical and asymmetrical.

15. The plug connection according to claim 1, wherein the locking part includes an insertion control feature which in the release position is configured to block the locking part against movement into the locking position when the first and second coupling parts are not fixed in position axially and radially by the retaining element.

16. The plug connection according to claim 1, wherein the locking part includes at least one actuation section and one locking arm, the locking arm including a radially moving section, a blocking section, insertion slant surface, an insertion control feature and anti-loss feature.

17. The plug connection according to claim 1, wherein the locking part comprises a feature configured to resist against accidental pulling or turning of the locking part from the locking position when in the assembled position of the plug connection.

18. (canceled)

19. (canceled)

20. (canceled)

21. (canceled)

22. (canceled)
